(19) United States
(12) Patent Application Publication
(10) Pub. No.: US 2006/0022038 A1
(43) Pub. Date: Feb. 2, 2006

(54) Mobile terminal finding system and method

(76) Inventors: Todd G. Hewlin, Southampton, NY (US); Hal Charych, Poquott, NY (US); Martin J. Strzelczyk, Farmingville, NY (US); Michael O'Haire, Smithtown, NY (US)

Correspondence Address: INGRASSIA FISHER & LORENZ, P.C., 7150 E. CAMELBACK, STE. 325, SCOTTSDALE, AZ, 85251, US

(21) Appl. No.: 10/909,252

(22) Filed: Jul. 29, 2004

(51) Int. Cl. G06F 19/00

(52) U.S. Cl. 235/385

(57) ABSTRACT

Methods and apparatus are provided for locating a mobile terminal in an RFID environment. The apparatus comprises a communicator coupled to the mobile terminal for instructing the terminal to enter a LOCATE mode, an RFID transceiver in the terminal that interrogates RFID tags while in the LOCATE mode to obtain information therefrom correlatable with their known positions, and a processor coupled to the RFID transceiver for determining the terminal location based at least in part on such information. Location determination may take place either in the terminal or a local network server or both. The tags may be either fixed position infrastructure tags or item tags that have been mapped in the local server or the terminal. Once the terminal location is determined, the terminal and/or server may announce and/or broadcast the terminal location.

### TECHNICAL FIELD

The present invention generally relates to location determination, and more particularly relates to determining the location of a mobile RFID capable terminal.

### BACKGROUND

Mobile terminals are widely used in many large facilities such as warehouses, stores, hospitals, schools, storage yards, ships, machine shops and many other businesses and locations. The functions of such terminals can be highly varied; for example and not intended to be limiting, data entry, inventory control, parts tracking, scanning objects for identifying information, reading documents, checking in rental cars, email terminals, communicators of various kinds, and so forth. The functions of such terminals can be highly varied; for example and not intended to be limiting, data entry, inventory control, parts tracking, scanning objects for identifying information, reading documents, checking in rental cars, email terminals, communicators of various kinds, and so forth. When the mobile terminal is misplaced finding it can be difficult. Certain methods are already used for this purpose. For example, if the device is coupled to a network and is capable of emitting an audible signal, it can be commanded through the network to generate a tone or sound that a person within hearing range can use to locate the terminal. Cordless phones are examples of mobile terminals with this capability. However, this approach is limited to situations where a person is within hearing distance of the misplaced terminal.

Thus, there continues to be a need for a terminal locating means and method that does not depend just on a listener being within hearing range. Accordingly, it is desirable to provide an improved apparatus and method for locating mobile terminals, especially an apparatus and method capable of operating with little human intervention. In addition, it is desirable that the terminal locating arrangement and method take advantage of existing capabilities in so far as possible. Further, it is desirable that the apparatus and method be multi-modal, that is, be capable of operating in different environments utilizing different signaling capabilities that may already exist for other purposes. Furthermore, other desirable features and characteristics of the present invention will become apparent from the subsequent detailed description and the appended claims, taken in conjunction with the accompanying drawings and the foregoing technical field and background.

### BRIEF SUMMARY

An apparatus is provided for locating a mobile terminal in an RFID environment. The apparatus comprises a communicator coupled to the mobile terminal for instructing the terminal to enter a LOCATE mode, an RFID transceiver in the terminal that interrogates RFID tags while in the LOCATE mode to obtain information therefrom correlatable with their known positions, and a processor coupled to the RFID transceiver for determining the terminal location based at least in part on such tag position information.

A method is provided for locating a mobile terminal in an RFID environment. The method comprises, placing the terminal in a LOCATE mode, transmitting an RFID tag interrogation signal to RFID tags in the vicinity, receiving responses from such RFID tags containing information correlatable with their known locations, and determining the terminal location at least in part based on such information.

### BRIEF DESCRIPTION OF THE DRAWINGS

The present invention will hereinafter be described in conjunction with the following drawing figures, wherein like numerals denote like elements, and

FIGS. 1A-1B are simplified schematic illustrations of the terminal locating arrangement of the present invention for two different locations of the mobile terminal with respect to its surroundings;

FIG. 2 is a simplified schematic illustration of the present invention similar to FIGS. 1A-1B showing further details of how the mobile terminal may be located with respect to its surroundings;

FIG. 3 is a simplified flow chart of a method of locating a mobile terminal according to the present invention;

FIGS. 4-6 are simplified flow charts similar to FIG. 3 of the method of the present invention for locating a mobile terminal, showing further details; and

FIG. 7 is a simplified electrical schematic diagram of the mobile terminal locating apparatus of FIGS. 1A-1C, showing still further details.

### DETAILED DESCRIPTION

The following detailed description is merely exemplary in nature and is not intended to limit the invention or the application and uses of the invention. Furthermore, there is no intention to be bound by any expressed or implied theory presented in the preceding technical field, background, brief summary or the following detailed description. For convenience of explanation the word “terminal” is intended to include any type of electronic apparatus having signaling capability, the word “mobile” is intended to refer to apparatus that is not fixed to a particular position, and the terms “warehouse,” “space,” “surroundings,” and equivalents are not intended to be limiting and to include any type of area, building, structure or workplace where a mobile terminal may be intended to be used.

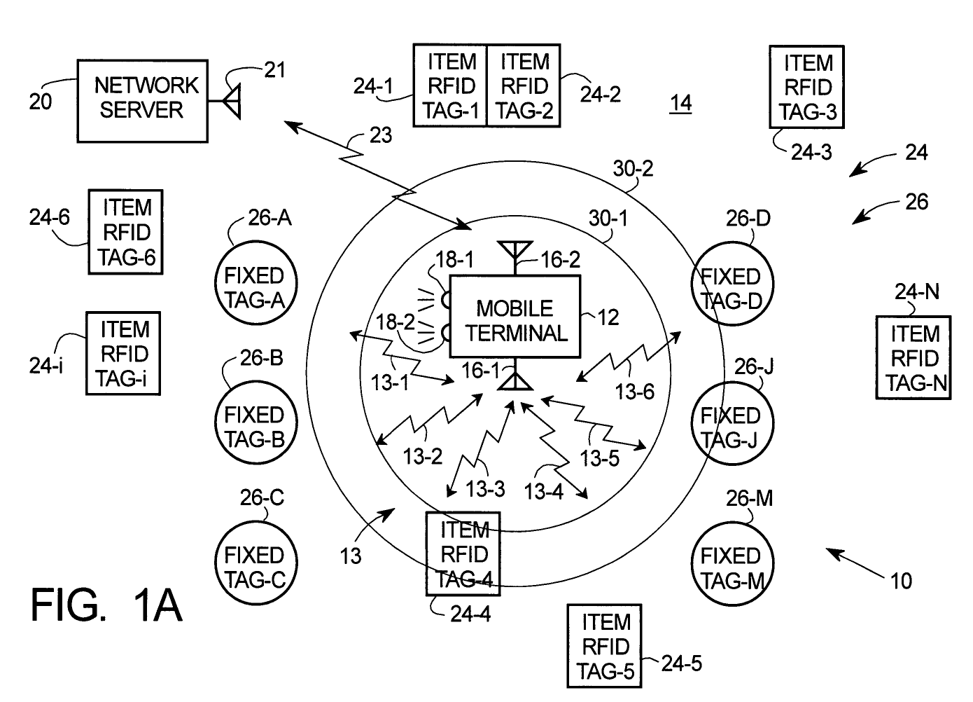

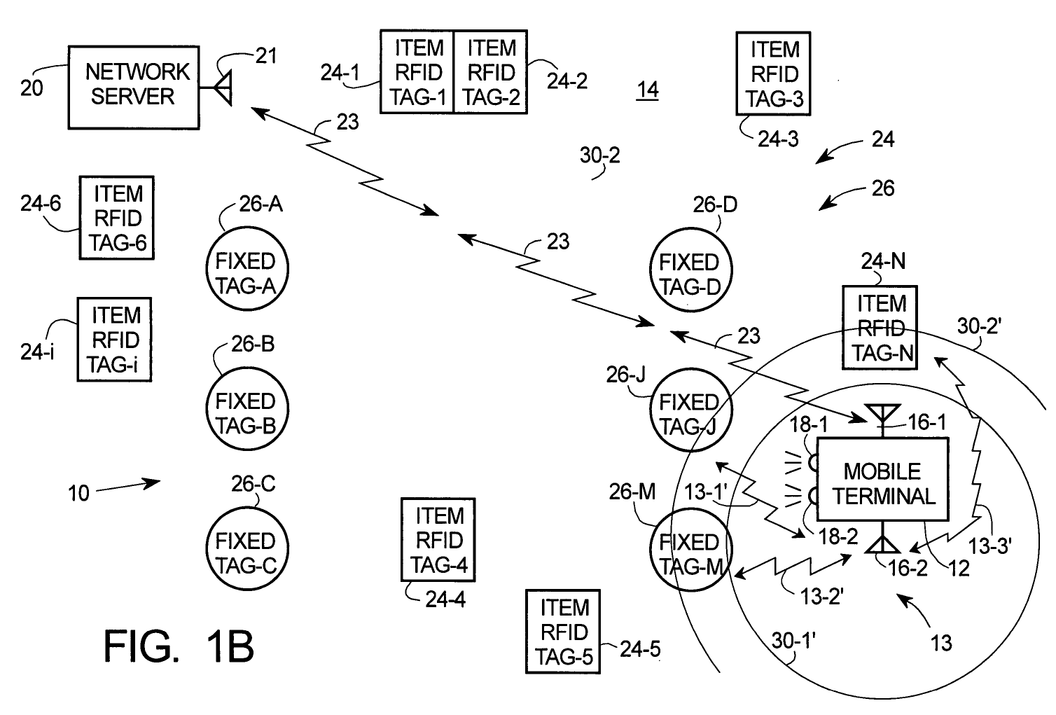

FIGS. 1A-1B are simplified schematic illustrations of terminal locating system 10 of the present invention for two different locations of mobile terminal 12 with respect to its surroundings 14 (e.g., a warehouse or other space). Mobile terminal 12 conveniently comprises one or more antennas 16-1, 16-2 (although these may be combined), and preferably but not essentially, one or more annunciators 18-1, 18-2. For example, annunciator 18-1 may be an audible annunciator and 18-2 a visual annunciator, or any other form of signaling device including a radio transmitter. Mobile terminal environment 14 conveniently includes network server or other communication device 20 with antenna 21, communicating with mobile terminal 12 as indicated by wireless path 23, preferably by RF signaling, but any other form of wireless communication may also be used.

In general, mobile terminal environment 14 also includes radio frequency identification (RFID) tags 24, 26 of one or more types. For example, and not intended to be limiting, RFID tags 24 (e.g. 24-1, 24-2, . . . 24-i, . . . , 24-N) may be associated with goods or other moveable items located in surroundings 14. These are identified in FIGS. 1A-1C by the designation “ITEM RFID TAG.” Tags 24 can be associated with the goods or items that warehouse or space 14 is intended to handle, that is, to temporarily store or sort for transshipment or other activity connected with the items identified by tags 24. Thus, tags 24 will often change in location as they move around in or move through warehouse or surroundings 14. In general, the presence and possibly the locations of tags 24 and associated goods will be monitored by network server 20, and for the purposes of this invention it is presumed that network server 20 (or other tag tracking system) has already determined the locations of tags 24 in space 14. Information on the locations of tags 24 may be stored in server 20 or transmitted by server 20 to terminal 12 or a combination thereof.

Surroundings 14 may also include RFID tags 26 (e.g., tags 26-A, 26-B, 26-C, 26-D . . . . 26-j, . . . 26-M), identified in FIGS. 1A-1C as “FIXED TAG.” Tags 26 differ from tags 24 in that tags 26 are fixed in place in surroundings 14 and are intended to act as addressable beacons having substantially permanently fixed (and known) locations. For example, tags 26 may be associated with the infrastructure of surroundings or space 14 with predetermined locations in space 14. The predetermined locations of tags 26 may be stored in network server 20 or in tags 26 themselves or terminal 12 or a combination thereof. Either arrangement works. FIGS. 1A-1B differ only in the location of mobile terminal 12 with respect to various tags 24, 26 in environment or space 14.

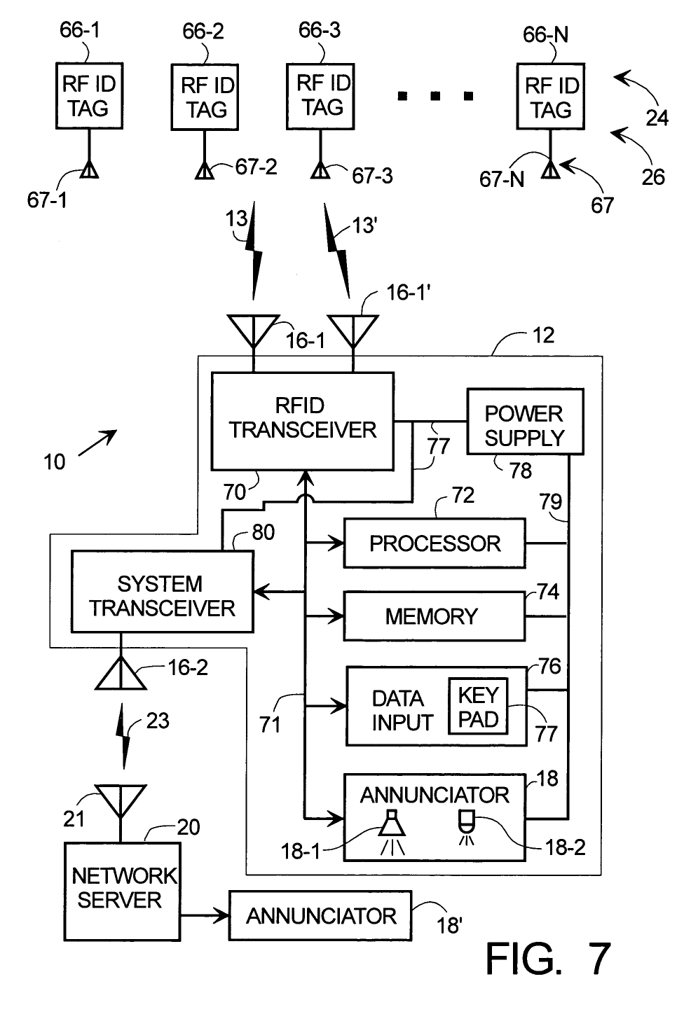

Tags 24, 26 may be any type of RFID tag able to respond with its unique identifier or other information that can be correlated with its location, when interrogated by a tag reader. The antennas associated with tags 24, 26 are omitted in FIGS. 1A-1C, but this is merely for convenience of illustration and persons of skill in the art will understand that each RFID tag has an antenna or analogous input-output element associated therewith. Such tags and associated antennas (see FIG. 7) are well known in the art and commonly available. As will be subsequently explained in more detail in connection with FIG. 7, mobile terminal 12 includes an RFID tag reader or interrogator, able to interrogate tags within its vicinity as indicated by arrows 13 and detect the responses provided by the tags in its vicinity, including information (such as but not limited to a unique identifier) that can be correlated with the known tag locations. Arrows 13 are intended to indicate 2-way communication between mobile terminal 12 and those tags within its wireless signaling range. While RF communication is preferred, any type of wireless signaling can be used for communication links 13. FIGS. 1A-1B differ only in the location of mobile terminal 12 with respect to various tags 24, 26 in its surrounding environment or space 14 (e.g., a warehouse, workspace, building, storage yard, etc.).

Outlines 30-1, 30-2 are intended to indicate the signaling range or sensitivity range of mobile terminal 12 with respect to tags 24, 26 in surroundings 14. As used herein, the term “sensitivity” and “communication range” or “signaling range” are intended to refer to the distance to and fro or the area around mobile terminal 12 within which it can detect a response from an RFID tag that it interrogates. For example, if the communication range of mobile terminal 12 is described by outline 30-1, then in FIG. 1A only tag 24-4 is within range to be detected by mobile terminal 12. Under these circumstances the best location that can be determined for terminal 12 is that it is within the radius of outline 30-1 of tag 24-4. Similarly, in FIG. 1B, for communication range outline 30-1′ only tag 26-M is in range and terminal 12 is thus known to be within radius of communication range 30-1′ of tag 26-M. Even though this may only be an approximate location it is better than having no information on the location of terminal 12, which is otherwise the case.

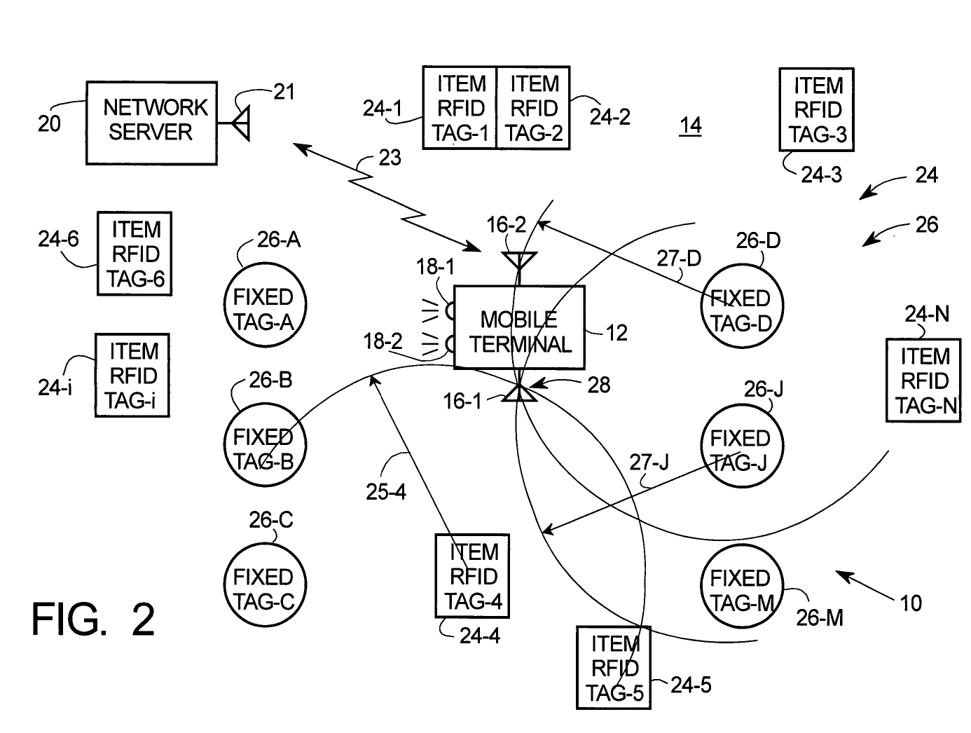

If the communication range of mobile terminal 12 is described by outline 30-2, then in FIG. 1A tags 24-4, 26-D and 26-j are within communication range and will be detected by terminal 12. Similarly, in FIG. 1B, for communication range outline 30-2′, only tags 24-N, 26-j and 26-M are in range to be detected by mobile terminal 12. Thus, mobile terminal 12 can determine its location in space 14 by interrogating those of tags 24, 26 in its vicinity, whose known location can then be used to locate terminal 12. Where only one tag is detected, then the location precision is determined by the tag detection radius. Where mobile terminal 12 is within communication range of multiple tags, then simple geometry can be used to increase the precision of the location determination, as shown for example in FIG. 2.

FIG. 2 is a simplified schematic illustration of the present invention similar to FIGS. 1A-1B showing further details of how mobile terminal 12 may be located with respect to surrounding space 14 containing various tags 24, 26. In FIG. 2, for convenience of explanation, mobile terminal 12 is in the same relative position as in FIG. 1A and, assuming a communication range described approximately by outline 30-2, terminal 12 detects tags 24-4, 26-D and 26-j. When interrogated, each RFID tag responds with its own unique identifier or other position correlatable information, so the properties associated with the particular tags are known or can be determined, either by server 20 and/or by terminal 12 or both. For example, given the known type of tag 24-4, terminal 12 should be able to interrogate and detect tag 24-4 approximately at radius 25-4 from tag 24-4. Similarly, terminal 12 should be able to interrogate and detect the responses from tags 26-D and 26-j at radii 27-D and 27-j from these tags, respectively. The perimeters (for simplicity, they are assumed to be circular) formed by detection radii 25-4, 27-D, 27-j intersect approximately at location 28, which is therefore the location of terminal 12 determined from the known locations of tags 24-4, 26-D and 26-j. While location 28 in FIG. 2 is shown as a point, this is merely for convenience of explanation and persons of skill in the art will understand that in most instances, the intersecting detection perimeters will describe an approximately triangular region rather than a point, where terminal 12 may be located anywhere within such region. Accordingly, the location of terminal 12 can be determined from the responses received from the tags it interrogates in combination with their known locations and approximate communication ranges. In general, the precision of the location information increases as more tags in its immediate vicinity are detected. Three tags are needed to unambiguously determine a location using the arrangement illustrated in FIG. 2, but this is not essential for the purposes of this invention. Once terminal 12 has detected the unique identifier(s) or other location correlatable information of the one or more tags in its vicinity, it can report this information back to server 20. The known location(s) of the detected tag or tags tags can be stored in server 20 or in terminal 12 and determining the position of terminal 12 based thereon may be performed in either location or both. Either arrangement works.

Once the location of terminal 12 is known, then annunciators 18 or 18′ (see FIGS. 1A-1C, 7) may be used to alert local personnel to the presence of the terminal or a message can be sent to such personnel in any way (e.g., by a PA system announcement), giving the coordinates of terminal 12 within space 14, or a combination thereof. For example, server 20 can broadcast a message over the local public address system or send it by radio signal to a portable communicator carried by personnel working in space 14 saying, for example, “Terminal one is located in aisle 7, bay G, shelf 4” or “Terminal seven is located in the northwest quadrant of the storage floor” or some such message depending upon the location determined for the terminal. Alternatively or in combination, terminal 12 may announce its own presence by a coded audio or optical signal where tones or the message, conveys location information to the listener. This is a significant improvement over the prior art where the misplaced terminal could only be caused to emit an audible or visual signal to aid in finding it, but could not include or broadcast any specific location information to tell the be searcher its current position.

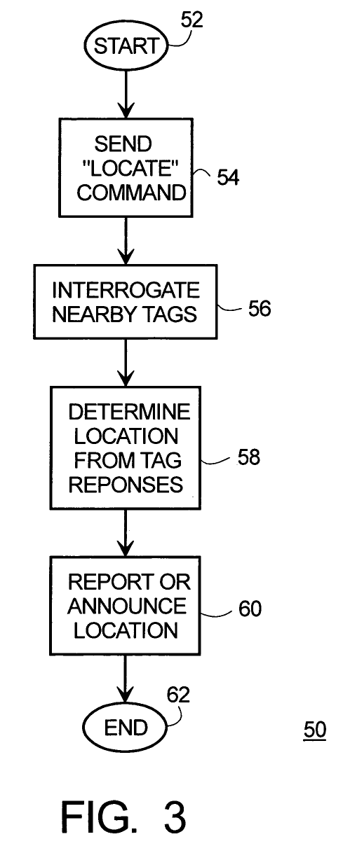

FIG. 3 is a simplified flow chart of method 50 of locating a mobile terminal according to the present invention. Method 50 begins with START 52 which desirably occurs on start-up of detection system 10, that is, when someone wants to find terminal 12 and initiates the find sequence. Initial step 54 is executed wherein server 20 (or any other communicator) desirably sends a “LOCATE” command to terminal 12 causing it in step 56 to interrogate the RFID tags in its vicinity and retrieve their unique IDs (in general, information correlatable with their locations). In subsequent step 58, the tag information obtained in step 56 is used to determine the tags' locations within space 14. This can be done in several ways. For example, by reporting the tag IDs (or other info) back to server 20 which uses the this information to retrieve the known tag locations from its memory or, alternatively, by retrieving the tag locations from memory within terminal 12, or alternatively, have the tag responses contain their location information or equivalent, or a combination of the above. Once the locations of the responding tags are known, then the procedure described, for example in connection s with FIGS. 1A-2 or any other method can be used to determine the location of terminal 12. In subsequent step 60, the location of terminal 12 determined in step 58 is announced or reported in any convenient manner to those needing this information. Non-limiting examples are, using annunciators 18, 18′ (see FIG. 7) to broadcasting or report the terminal coordinates or issue an audible or visual signal or a combination thereof in any useful way. Following reporting and/or announcing step 60, method 50 conveniently proceeds to END 62.

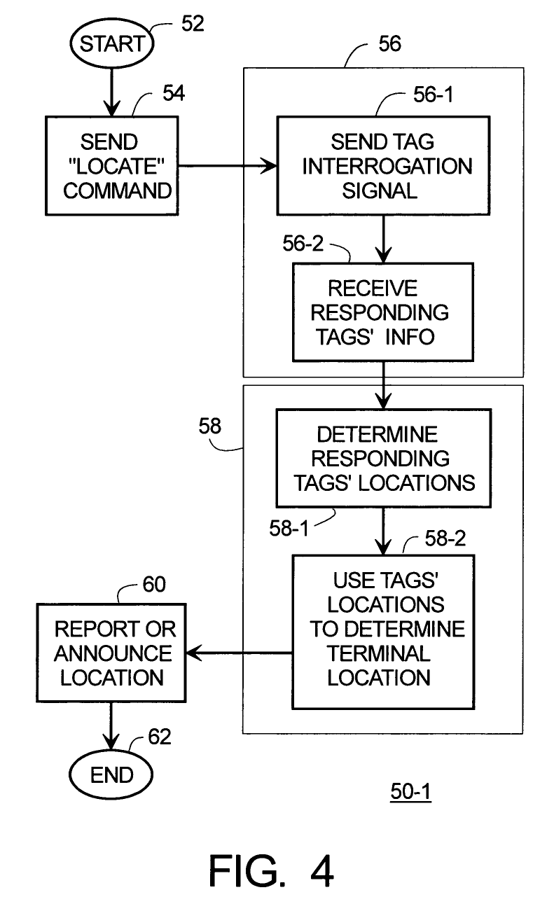

FIGS. 4-6 are simplified flow charts of methods 50-1, 50-2, 50-3 analogous to method 50 of FIG. 3 of the present invention for locating a mobile terminal, showing further details. Like reference numbers are used for equivalent steps. Referring now to FIG. 4, step 54 is the same as in FIG. 3 but subsequent step 56 is broken down into sub-step 56-1 wherein terminal 12, in response to the command received in step 54, broadcasts an interrogation signal and sub-step 56-2 wherein it receives responses from the nearby tags and extracts their unique IDs or other location correlatable information. Step 58 is broken down into sub-steps 58-1 and 58-2. In sub-step 58-1 the location correlatable information obtained in sub-step 56-2 is used to determine the locations of these tags. In sub-step 58-2, the tag locations determined in step 58-1 are used to determine the location of terminal 12, e.g., by proximity, calculation or other appropriate means. Steps 60, 62 then follow as before.

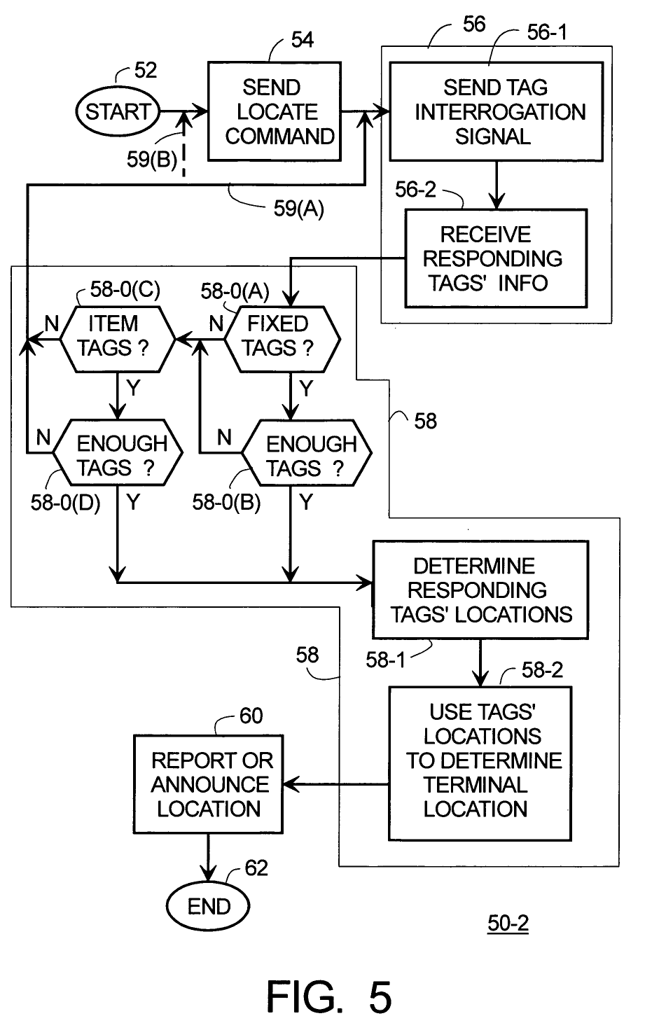

Referring now to FIG. 5, steps 52, 54, 56-1, 56-2 are as previously described. Following sub-step 56-2, query 58-0(A) is executed wherein it is determined whether or not the received tag information corresponds to FIXED TAGS or not. (In general, using fixed tags for locating terminal 12 is preferred since their location is known with great precision and does not change with time.) If the outcome of query 58-0(A) is YES (TRUE), the method 50-2 proceeds to ENOUGH TAGS ? query 58-0(B) wherein it is determined whether or not enough FIXED TAGS were detected to obtain a location solution of the desired accuracy, as determined by the designer or user. If the outcome of query 58-0(B) is YES (TRUE) then method 50-2 proceeds to steps 58-1, 58-2, 60, 62 as before. If the outcome of either queries 58-0(A) or 58-0(B) is NO (FALSE), then method 50-2 proceeds to query 58-0(C) wherein it is determined whether ITEM TAGS were detected. If the outcome of query 58-0(C) is YES (TRUE) then method 50-2 proceeds to ENOUGH TAGS ? query 58-0(D) wherein it is determined whether the total number of detected FIXED and ITEM tags are sufficient to make a location determination according to the criteria provided by the user or designer. If the outcome of query 58-0(D) is YES (TRUE) then method 50-2 proceeds to steps 58-1, 58-2, 60, 62 as before. If the outcome of either queries 58-0(C) or 58-0(D) is NO (FALSE), then method 50-2 returns to step 56 as shown by path 59(A) or optionally to step 54 as shown by path 59(B), and the method repeats until sufficient tags are identified to determine a location for terminal 12 or until a timeout (not shown) is reached.

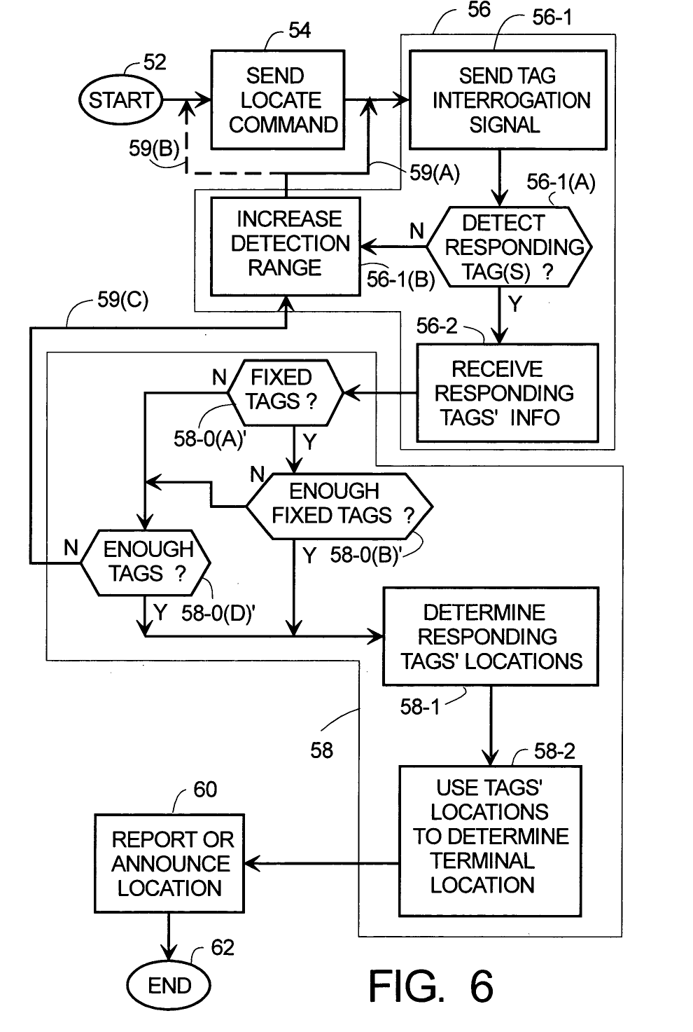

Referring now to FIG. 6, steps 52, 54, 56-1, 56-2, 58-0(A)′, 58-0(B)′, 58-0(D)′, 58-1, 58-2, 60, 62 are analogous to equivalent steps previously described. In the arrangement of FIG. 6, advantage is taken of varying the communication range for detecting tags 24, 26, that is, of varying the size of detection regions 30. In method 50-3 of FIG. 6, the initial interrogation transmission in step 56-1 is desirably carried out at low power and/or with decreased sensitivity to tag response so that communication range 30 is small. Following step 56-1, DETECT RESPONDING TAG(S) ? query 56-1(A) is executed wherein it is determined whether or not any tags responded. If the outcome of query 56-1(A) is NO (FALSE) then method 50-3 proceeds to step 56-1(B) wherein communication range 30 is increased and method 50-3 then proceeds by path 59(A) or 59(B) back to steps 56-1 or 54 respectively and the interrogation and detection steps repeated until the outcome of query 56-1(A) is YES (TRUE) whereupon method 50-3 proceeds to step 56-2 or a timeout (not shown) occurs. The threshold for obtaining a YES (TRUE) outcome from query 56-1 (A) can be varied depending upon the needs of the user. For example, if space 14 is very open so that terminal 12 could be seen from a considerable distance then, having only one tag respond may be sufficient. On the other hand, if the surroundings are very congested and a higher location precision is needed, it may be desirable to set the threshold level of query 56-1(A) to only yield YES (TRUE) when at least three tags have responded, or a particular mix of FIXED and ITEM tags have responded or any other suitable combination. Persons of skill in the art will understand based on the teachings herein how to select an appropriate detection sensitivity level or tag communication radius. The advantage of method 50-3 is that the number and proximity of responding tags may be varied and thereby adapt to the user's circumstances. Once a sufficient number of tags has been detected and their responses received in step 56-2, then method 50-3 proceeds through steps 58-0(A)′, 58-0(B)′ and 58-0(D)′ analogous to steps 58-0(A), 58-0(B), 58-0(D) as previously described in connection with FIG. 5. If the outcomes of steps 58-0(B)′ or 58-0(D)′ are YES (TRUE), then method 50-3 proceeds to steps 58-1, 58-2, 60, 62 and if the outcome of query 58-0(D) is NO (FALSE) then method 50-3 loops back to step 56-1(B) as shown by path 59(C) until a successful outcome is obtained or a timeout (not shown) occurs. Query 58-0(C) of FIG. 5 is not needed in method 50-3 of FIG. 6 since the outcome is predetermined according to the results of queries 56-1(A) and 58-0(A)′. While method 50-3 is described in terms of starting with a small tag detection range and in step 56-1(B) increasing the detection range until one or more tags are detected in step 56-1(A), this is not essential. Alternatively, method 50-3 can initially use a large detection range in which many tags are likely to be detected, and on each iteration of steps 56-1, 56-1(A), 56-1(B) decrease the detection range until only one or no tags are detected in query 56-1(A), and then use this information in steps 56-2 and following to provide location information. Either arrangement is useful. What is desirable in method 50-3 is that the tag detection radius or communication range be varied in a predetermined way.

FIG. 7 is a simplified electrical schematic diagram of mobile terminal 12 and associated locating apparatus of system 10 of FIGS. 1A-1C for locating terminal 12, showing still further details. In the example of FIG. 7, tags 66-1, 66-2, 66-3 . . . 66-N are analogous to tags 24, 26 of FIGS. 1A-1C. Antennas 67-1, 67-2, 67-3 . . . 67-N associated with tags 66-1, 66-2, 66-3 . . . 66-N are also illustrated. Terminal 12 has antenna 16-1 that may handle both transmission of RF interrogation signal 13 and reception of tag response signal 13′, or separate receiving antenna(s) 16-1′ may be provided. Either or both arrangements are useful. For example, mobile terminal 12 may be provided with multiple antennas, where one or more serve different types of tags. Persons of skill in the art will understand which arrangement better suits their needs depending upon the types of tags 66 intended to be interrogated and the regular functions to be performed by terminal 12. Terminal 12 is moveable with respect to tags 66.

Terminal 12 conveniently comprises RFID transceiver 70 for interrogating tags 66 (24, 26), processor 72, memory 74, annunciator 18 and power supply 78. Terminal 12 also desirably includes data input 76 and system transceiver 80. Transceivers 70, 80, processor 72, memory 74, data input 76 and annunciator 18 are coupled and intercommunicate by bus or leads 71. Power supply 78 is coupled to transceivers 70, 80 by power leads 77 and to processor 72, memory 74, data input 76 and annunciator 18 by power leads 79. It is desirable that power supply 78 be self-contained, as for example, using batteries, so that terminal 12 is freely portable but this is not essential. Power supply 78 can be connected to external power mains by an extension cord (not shown), but this is less desirable since it limits the overall mobility of terminal 12. In the preferred embodiment, terminal 12 is powered by a battery. However, other types of portable energy sources can be used, for example and not intended to be limiting, a fuel cell, high-energy capacitor or a combination thereof. As used herein, the word “battery” is intended to include these and any other kind of portable power source of suitable voltage and current capacity. It is preferable that memory 74 contain non-volatile memory (as well as transient memory) where it is desired to store tag locations or other non-volatile information within terminal 12. It is desirable that data input 76 have keypad 77 whereby the user of terminal 12 may provide various commands associated with the ordinary functions of terminal 12. System transceiver 80 with antenna 16-2 is provided to allow network server 20 with antenna 21 to communicate wither terminal 12 and vice-versa over wireless link 23. While element 80 is identified as a transceiver and that is preferred, it is only essential for the present invention that it be capable of receiving an external command to initiate the “LOCATE” mode as has been previously described. Thus, for the purposes of the present invention element 80 can be a simple receiver capable of receiving any kind of LOCATE mode initiating command. However, the regular functions of terminal 12 may make use transceiver 80 for other purposes as well. Similarly, while element 20 of system 10 is identified as a network server and this is preferred, it is not essential. For the present invention, all that is needed is that element 20 have sufficient communication capability to send a command to terminal 12. Thus, element 20 can be a simple transmitter capable of sending an “enter LOCATE mode” command signal that will be understood by terminal 12. However, the ordinary functions of terminal 12 may make use server 20 for other purposes as well. Thus, as used herein the terms “systems transceiver” for element 80 and “network server” for element 20 are intended to be understood in this broader context, that is, merely being capable of triggering the LOCATE mode and/or being capable of such other more complex functions as may be appropriate for the regular functions of terminal 12.

When processor 70 receives a “LOCATE” command from server 20 via transceiver 80, then RFID transceiver 70 desirably but not essentially acting under the direction of processor 72, broadcasts RFID interrogation signal 13 toward tags 66 analogous to tags 24, 26 of FIGS. 1A-2. Those of tags 66 that are within RF communication range perimeter 30 (see FIGS. 1A-2) will respond with signal 13′. It is desirable but not essential that transceiver 70 be capable of measuring at least the relative strength of received signals 13′. Signal 13 can be a repetitive signal so that a series of responses 13′ is received by transceiver 70 from tags 66 within communication range 30. The received signals desirably include the unique identifier (e.g., the ID #'s) of the interrogated tags or other information that is correlatable with their known locations. This information is either used by processor 72 to retrieve tag locations from memory 74 or processor 72 sends the information via transceiver 80 to network server 20 where the equivalent process occurs, or a combination thereof. The net result is that the known location of the responding tags is determined and then used as has been previously described either by processor 72 and/or server 20 or otherwise to locate terminal 12. When the location is determined, then processor 72 and/or server 20 can cause a visual or audible and/or other signal to be emitted by annunciator 18 and/or 18′. For example, light 18-2 may illuminate or flash, and speaker 18-1 may emit a beep or tone (continuous or intermittent or frequency varying tone(s) and/or a predetermined voice message). Server 20 can also broadcast the coordinates found for terminal 12. The power output and/or the sensitivity of transceiver 70 can be varied (e.g., by processor 72) in order to execute the method steps illustrated in FIG. 6 wherein the RFID communication range of terminal 12 in the LOCATE mode is varied in order to enhance or customize the locate function.

The apparatus and method described above provide the capability to locate terminal 12 while terminal 12 is passive, that is, not being used by an operator. This is extremely useful and provides a solution to the “lost terminal” problem often encountered with mobile terminals. However, the present invention may also be used to locate terminal 12 while it is active, that is, being used by an operator or simply functioning remotely even without an operator. Whether or not a terminal is active can be determined, for example by server 20, from whether data is being entered, for example, via keypad 77 or other input coupled to data entry element 76. If the terminal is such that the user must enter a personal code to activate it, then server 20 will know not only that it is active, but also which person is using the terminal. When a “LOCATE” command is sent to terminal 12, processor 70 can enter an interrupt mode wherein it causes the steps described in connection with FIGS. 3-6 to be executed to determine the terminal location relative to the surrounding (known position) tags. This information can then be reported by to server 20 via transceiver 80. Thus, apparatus 10 can be used to locate an operator and/or an active terminal as well as a passive terminal. This is extremely useful since this information can be used to efficiently dispatch additional workers and or machinery (e.g., cargo handlers) or other objects or functions to various parts of the work space. This is a further feature of the present invention.

While at least one exemplary embodiment has been presented in the foregoing detailed description, it should be appreciated that a vast number of variations exist. For example, while operation of system 10 using a network server is preferred, it is not essential. The LOCATE function can be self contained within terminal 12, triggered by a WAKE-UP command of any sort, independent of the network server. Locations of the FIXED (or other known location) tags can be stored in memory 74 and the locate function carried out entirely by terminal 12. In this situation, it is desirable that once the terminal has determined its own location, that it broadcast its location so that it can be found. This annunciator function can be audible, optical, via a wireless signal to a receiver giving its coordinates or a combination thereof. Conversely, in facilities 14 that do not have a fixed beacon tag infrastructure already installed but which contains a significant number of ITEM tags 24, the location of these ITEM tags is usually already stored in the local network server 20. The mobile terminal interrogates these ITEM tags, obtains their unique ID#s which are then correlated with their locations stored in the network server. This location information is generally sufficient to allow the location of terminal 12 to be determined using the ITEM tag map in the server. The server then causes the location of the terminal to be announced in a suitable manner (e.g., via an audible, optical, wireless signal, combination thereof, etc.). The present invention is described in terms of interrogating conventional RFID tags in known or determinable locations. However, any type of wireless communication device that can be made to respond when interrogated with information and/or an ID# correlatable with its known location will also serve and, as used herein, the terms “RFID” and “RFID tag” singular or plural are intended to include such other elements and not be limited merely to currently known types of radio frequency tags.

It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. An apparatus for locating a mobile terminal in an RFID environment, comprising:
apparatus coupled to the mobile terminal for instructing the terminal to enter a LOCATE mode;
an RFID transceiver in the terminal that interrogates nearby RFID tags to obtain information therefrom correlatable with their known positions;
a processor coupled to the RFID transceiver for using the information received from the responding RFID tags to determine their known locations and determine the terminal location based at least in part on the RFID tag locations.

2. The apparatus of claim 1 further comprising memory for storing tag locations.

3. The apparatus of claim 2 wherein the memory for storing tag locations is outside the terminal.

4. The apparatus of claim 2 wherein the memory for storing tag locations is within the terminal.

5. The apparatus of claim 1 wherein the nearby RFID tags comprise at least in part, fixed tags.

6. The apparatus of claim 5 wherein the fixed tags transmit their location when interrogated.

7. The apparatus of claim 5 wherein the apparatus further comprises memory coupled to the processor and wherein fixed tags locations are stored in memory.

8. The apparatus of claim 2 wherein the nearby tags comprise at least in part moveable tags whose current locations are mapped into the memory.

9. The apparatus of claim 1 further comprising an annunciator for alerting users to the location of the terminal determined by the processor.

10. The apparatus of claim 9 wherein the annunciator sends a signal containing information on the location of the terminal.

11. The apparatus of claim 9 wherein the annunciator provides an audio, visual or combination signal alerting users to the location of the terminal.

12. The apparatus of claim 1 wherein the processor is located within the terminal.

13. The apparatus of claim 1 wherein the processor is located outside the terminal.

14. The apparatus of claim 10 wherein the signal differs depending upon the location of the terminal.

15. The apparatus of claim 11 wherein the signal differs depending upon the location of the terminal.

16. A method for locating a mobile terminal in an RFID environment, comprising:
placing the terminal in a LOCATE mode;
transmitting an RFID tag interrogation signal from the terminal toward RFID tags;
receiving responses from nearby RFID tags containing information correlatable with their locations; and
determining the terminal location at least in part based on the RFID tag responses.

17. The method of claim 16 further comprising after the determining step, sending a signal related at least in part to the terminal location.

18. The method of claim 16 wherein the determining step comprises
determining what type of tags have responded; and
if sufficient FIXED tags have responded, using information received from said FIXED tags in determining the terminal location.

19. The method of claim 18, wherein if sufficient FIXED tags have not responded, also using information from ITEM tags in determining the terminal location.

20. The method of claim 16 wherein the transmitting and receiving steps comprise:
adjusting the communication range of the transmitted or received or both signals to a first level, then
determining whether or not tags have responded, and
adjusting the communication range to a different level to alter the number of responding tags.

21. A method for locating an active terminal, comprising:
sending an ENTER LOCATE MODE signal to the terminal;
causing a transceiver aboard the terminal to transmit an RFID tag interrogation signal toward nearby RFID tags;
receiving responses from the nearby RFID tags containing information correlatable with their locations; and
determining the terminal location at least in part based on the RFID tag responses.

22. The method of claim 21 further comprising prior to the sending step receiving data from the terminal.

23. The method of claim 22 wherein the data received from the terminal comprises a personal identifier.

24. the method of claim 23 further comprising sending a signal related to the terminal location and the personal identifier.

25. The method of claim 21 further comprising sending a signal related to the terminal location.
